(19) United States
(12) Patent Application Publication
(10) Pub. No.: US 2018/0068477 A1
(43) Pub. Date: Mar. 8, 2018

(54) DISPLAY METHOD, DISPLAY DEVICE, AND NON-TRANSITORY COMPUTER-READABLE RECORDING MEDIUM

(71) Applicant: FUJITSU LIMITED, Kawasaki-shi (JP)

(72) Inventors: Yoshimi YUFU, Narita (JP); Seiji KURIMOTO, Yokohama (JP); Yoriko YAMADA, Mishima (JP); Yoko MIURA, Kawasaki (JP); Takanori HAMANO, Yokohama (JP); Yumiko YAMAGATA, Kawasaki (JP); Satoshi WAKABAYASHI, Yokohama (JP)

(73) Assignee: FUJITSU LIMITED, Kawasaki-shi (JP)

(21) Appl. No.: 15/693,602

(22) Filed: Sep. 1, 2017

(30) Foreign Application Priority Data
Sep. 6, 2016 (JP) 2016-173647

(51) Int. Cl. G06T 11/60; G06T 7/73

(52) U.S. Cl. CPC G06T 11/60; G06T 7/536; G06T 7/74

(57) ABSTRACT

A display method executed by a computer. The method includes receiving an image captured by a camera, detecting a reference object in the image, receiving designation indicating a first position in the image, determining a size of an object in accordance with the first position and a captured shape of the reference object in the image, and superimposing the object on the first position with the determined size.

### CROSS-REFERENCE TO RELATED APPLICATION

This application is based upon and claims the benefit of priority of the prior Japanese Patent Application No. 2016-173647, filed on Sep. 6, 2016, the entire contents of which are incorporated herein by reference.

### FIELD

The embodiments discussed herein are related to a technology by which display is controlled.

### BACKGROUND

Recently an augmented reality (AR) technology has been proposed by which object data is overlaid on a captured image, using, for example, a smartphone, a tablet terminal, or the like. In the AR technology, a marker that is a display reference of the object data is attached, for example, to a product, a floor surface, or the like. When a content corresponding to the attached marker is generated, authoring is performed to arrange object data on a captured image including the marker. In the authoring, when the captured image has a depth, the display size of the object data to be arranged is enlarged or reduced in accordance with the depth.

### SUMMARY

According to an aspect of the invention, a method includes receiving an image captured by a camera, detecting a reference object in the image, receiving designation indicating a first position in the image, determining a size of an object in accordance with the first position and a captured shape of the reference object in the image, and superimposing the object on the first position with the determined size.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a display control system according to an embodiment;

FIG. 2 is a diagram illustrating an example of an object data storage unit;

FIG. 3 is a diagram illustrating an example of a perspective information storage unit;

FIG. 4 is a diagram illustrating an example of setting of a vanishing point;

FIG. 5 is a diagram illustrating an example of a perspective;

FIG. 6 is a diagram illustrating an example of a depth level;

FIG. 7 is a diagram illustrating an example of a perspective enlarged after setting of the depth level;

FIG. 8 is a diagram illustrating an example of a perspective on a floor surface corresponding to a marker on a wall surface;

FIG. 9 is a diagram illustrating an example of a change in the display size of object data;

FIG. 10 is a diagram illustrating another example of a change in the display size of object data;

FIG. 11 is a flowchart illustrating an example of perspective generation processing according to the embodiment;

FIG. 12 is a flowchart illustrating an example of arrangement processing according to the embodiment; and

FIG. 13 is a diagram illustrating an example of a computer that executes a display control program.

### DESCRIPTION OF EMBODIMENTS

For example, in a case in which a lot of pieces of object data are arranged, when a user who generates a content enlarges and reduces the pieces of object data manually, it is desirable for the user to perform an operation to set the respective display sizes of the plurality of pieces of object data. Therefore, when a lot of pieces of object data are arranged, the operation become complex, and the labor effort of the user increases.

In one aspect, the object of an embodiment of the technology discussed herein is to easily set the display size of object data.

Embodiments of a display control program, a display control method, and an information processing device of the technology discussed herein are described below in detail with reference to drawings. The technology discussed herein is not limited to such embodiments. In addition, the following embodiments may be combined as appropriate within a range not contradicting.

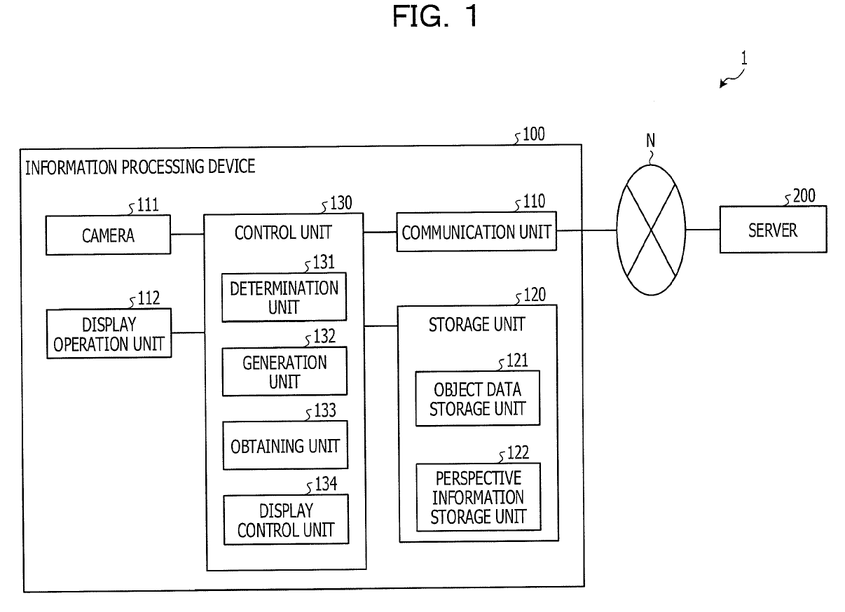

FIG. 1 is a block diagram illustrating an example of a configuration of a display control system according to an embodiment. A display control system 1 illustrated in FIG. 1 includes an information processing device 100 and a server 200. As the information processing device 100, for example, a mobile communication terminal or the like such as a tablet terminal or a smartphone may be used. In FIG. 1, a single information processing device 100 is described as an example, but the number of information processing devices 100 is not limited, and the specific number of information processing devices 100 may be used.

The information processing device 100 and the server 200 are coupled to each other so as to communicate with each other through a network N. As such a network N, a specific type of a communication network such as the Internet, a local area network (LAN), or a virtual private network (VPN) may be used regardless of a wired or wireless communication.

When the information processing device 100 receives an image captured by an imaging device, the information processing device 100 determines whether an image of a reference object is included in the captured image. When the image of the reference object is included in the captured image, the information processing device 100 generates information used associate information corresponding to a degree of separation with the part, based on the shape of the image of the reference object. When the information processing device 100 detects an operation to associate the object data with a certain part in the captured image, the information processing device 100 obtains information corresponding to a degree of separation associated with the certain part, with reference to the generated information. The information processing device 100 displays the object data on the captured image with the size corresponding to the information corresponding to the obtained degree of separation. As a result, the information processing device 100 may set the display size of the object data easily.

The server 200 includes a database that manages an AR content, for example, for equipment inspection at a factory as object data. The server 200 transmits the object data to the information processing device 100 through the network N, in response to a request from the information processing device 100. In addition, the server 200 includes a database that stores perspective information generated in the information processing device 100. The server 200 transmits the perspective information to the information processing device 100 through the network N in response to a request from the information processing device 100.

A configuration of the information processing device 100 is described below. As illustrated in FIG. 1, the information processing device 100 includes a communication unit 110, a camera 111, a display operation unit 112, a storage unit 120, and a control unit 130. It may be assumed that the information processing device 100 includes various function units of a known computer, for example, various function units such as an input device, and an audio output device in addition to the function units illustrated in FIG. 1.

The communication unit 110 is realized by a third generation mobile communication system, a mobile phone line such as long term evolution (LTE), a communication module such as a wireless LAN, or the like. The communication unit 110 is a communication interface that is coupled to the server 200 through the network N and administers communication of information with the server 200. The communication unit 110 transmits a data obtaining instruction input from the control unit 130 or generated perspective information, to the server 200 through the network N. In addition, the communication unit 110 receives object data corresponding to the data obtaining instruction from the server 200 through the network N. The communication unit 110 outputs the received object data to the control unit 130. In addition, the communication unit 110 may transmit a perspective information obtaining instruction to the server 200 through the network N, and receive perspective information corresponding to the perspective information obtaining instruction, from the server 200 through the network N. The communication unit 110 outputs the received perspective information to the control unit 130.

The camera 111 is an example of an imaging device and is provided, for example, on the back surface of the information processing device 100, that is, on the opposite surface to the display operation unit 112 to capture an image of the surrounding. The camera 111 captures an image, for example, using a complementary metal oxide semiconductor (CMOS) image sensor, a charge coupled device (CCD) image sensor, or the like, as an imaging element. The camera 111 generates an image by performing photoelectric conversion and analog/digital (A/D) conversion on light received through the imaging element. The camera 111 outputs the generated image to the control unit 130.

The display operation unit 112 corresponds to a display device used to display various pieces of information and an input device that accepts various operations from the user. For example, the display operation unit 112 is realized by a liquid-crystal display or the like as the display device. In addition, for example, the display operation unit 112 is realized by a touch panel or the like as the input device. That is, the display operation unit 112 is obtained by integrating the display device and the input device. The display operation unit 112 outputs an operation input by the user, to the control unit 130 as operation information.

The storage unit 120 is realized, for example, by a storage device such as a random access memory (RAM) or a semiconductor memory element including a flash memory. The storage unit 120 includes an object data storage unit 121 and a perspective information storage unit 122. In addition, the storage unit 120 stores information used for processing in the control unit 130.

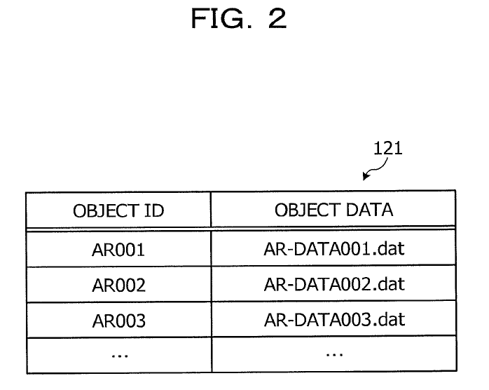

The object data storage unit 121 stores object data used for authoring, obtained from the server 200. FIG. 2 is a diagram illustrating an example of the object data storage unit. As illustrated in FIG. 2, the object data storage unit 121 includes items of “object identifier (ID)” and “object data”. The object data storage unit 121 stores one record, for example, for each piece of object data.

Here, “object ID” is an identifier used to identify object data, that is, an AR content. Here, “object data” is information indicating the object data obtained from the server 200. Here, “object data” is, for example, a data file that constitutes the object data, that is, the AR content.

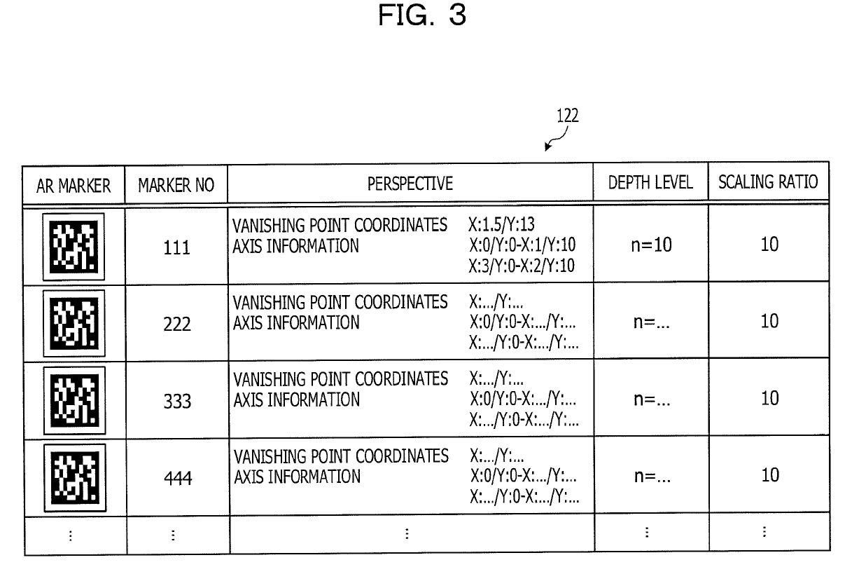

Returning to FIG. 1, the perspective information storage unit 122 stores perspective information that is information used to associate information corresponding to a degree of separation with the part. The part in the captured image indicates, for example, the position of a pixel or the like on the captured image. In addition, the degree of separation may correspond to distance between the camera 111 and subject position, for example. The subject position may indicate the actual position of a subject captured in the part included in the captured image. FIG. 3 is a diagram illustrating an example of the perspective information storage unit. As illustrated in FIG. 3, the perspective information storage unit 122 includes items of “AR marker”, “marker No”, “perspective”, “depth level”, and “scaling ratio”. The perspective information storage unit 122 stores, for example, one record for each “marker No”.

Here, “AR marker” is information indicating an image of a maker that is a reference object. In addition, “marker No” is an identifier used to identify a marker. In addition, “perspective” is information indicating vanishing point coordinates and axis information of a perspective, viewed in a perspective view. In addition, “depth level” is information used to identify a depth in the perspective. In addition, “scaling ratio” is information indicating a ratio of the expansion or contraction of the perspective.

The control unit 130 is realized, for example, when a program stored in an internal storage device is executed by a central processing unit (CPU), a micro processing unit (MPU), or the like, using the RAM as a work area. In addition, the control unit 130 may be realized, for example, by an integrated circuit such as a field programmable gate array (FPGA) or an application specific integrated circuit (ASIC). The control unit 130 includes a determination unit 131, a generation unit 132, an obtaining unit 133, and a display control unit 134, and realizes or executes a function and an operation of information processing described below. An internal configuration of the control unit 130 is not limited to the configuration illustrated in FIG. 1, and may be another configuration as long as the information processing described below is executed in the configuration.

In addition, the control unit 130 obtains object data used for authoring from the server 200 in advance and stores the object data in the object data storage unit 121 in order to perform the authoring.

For example, when an imaging instruction is input to the determination unit 131 from the user, the determination unit 131 instructs the camera 111 to perform imaging, and receives a captured image input from the camera 111. The determination unit 131 receives the input captured image, for example, a still image. The determination unit 131 determines whether an image of a reference object, that is, a marker is included in the captured image. When a marker is not included in the captured image, the determination unit 131 continues to wait for input of a captured image. When a marker is included in the captured image, that is, the determination unit 131 detects the marker from the captured image, the determination unit 131 outputs a perspective generation instruction to the generation unit 132. When the marker is included in the captured image, the determination unit 131 continues to display the captured image on the display operation unit 112 until arrangement of object data is completed.

When the perspective generation instruction is input to the generation unit 132 from the determination unit 131, the generation unit 132 generates perspective information based on the shape of the marker. That is, when the image of the reference object is included in the captured image, the generation unit 132 generates information used to associate information corresponding to a degree of separation between the camera 111 and the subject position with the part, based on the shape of the image of the reference object.

First, the generation unit 132 detects the four sides of the detected marker. The generation unit 132 sets a vanishing point from line segments obtained by extending two sides from among the detected four sides and that intersect with each other. In addition, the generation unit 132 extends the two sides from the set vanishing point and generates two axes of the perspective. The generation unit 132 may correct distortion of the marker before the detection of the four sides of the marker.

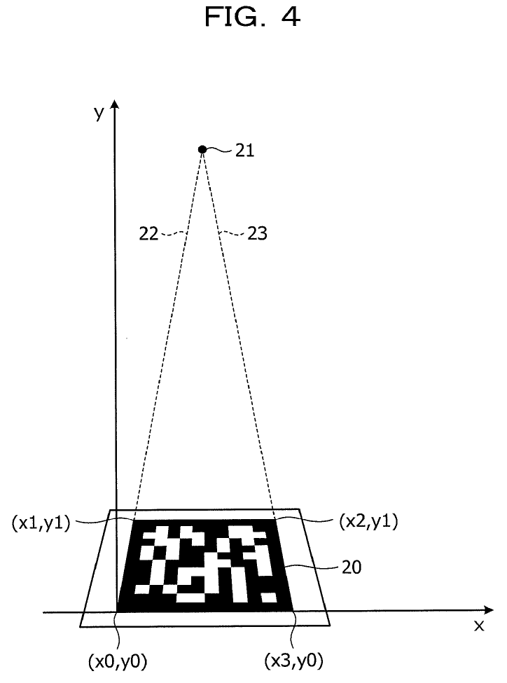

Here, setting of a vanishing point and generation of two axes of a perspective are described with reference to FIG. 4. FIG. 4 is a diagram illustrating an example of setting of a vanishing point. As illustrated in FIG. 4, the generation unit 132 sets a marker coordinate system using the coordinates of one of the four corners of a marker 20 as an origin point. The generation unit 132 sets a vanishing point 21 based on the coordinates of the four corners of the marker 20 in the set marker coordinate system, using the following formulas (1) and (2). Here, it is assumed that the coordinates of the four corners of the marker 20 are, for example, (x0,y0), (x1,y1), (x2,y1), and (x3,y0). In addition, “p” indicates the X coordinate of the vanishing point 21, and “q” indicates the Y coordinate of the vanishing point 21.

$$\begin{matrix}( \begin{matrix}x 1 & y 1 \\ x 0 & y 0\end{matrix} ) ( \begin{matrix}x \\ y\end{matrix} ) = ( \begin{matrix}p \\ q\end{matrix} ) & ( 1 ) \\ ( \begin{matrix}x 2 & y 1 \\ x 3 & y 0\end{matrix} ) ( \begin{matrix}x \\ y\end{matrix} ) = ( \begin{matrix}p \\ q\end{matrix} ) & ( 2 )\end{matrix}$$

That is, the generation unit 132 sets, as the vanishing point 21, an intersection point between a line segment 22 obtained by extending the side that connects (x0,y0) and (x1,y1) of the marker 20 and a line segment 23 obtained by extending the side that connects (x2,y1) and (x3,y0) of the marker 20.

The generation unit 132 generates two axes of the perspective by extending the two sides from the set vanishing point 21. That is, the generation unit 132 sets the line segments 22 and 23 as the two axes of the perspective. The generation unit 132 sets the perspective, for example, using (x1,y1), (x2,y1), and specific coordinates between which values of the Y axis on the line segments 22 and 23 are same. It may be assumed that the two axes of the perspective ranges from the sides of the marker 20 to the vanishing point 21.

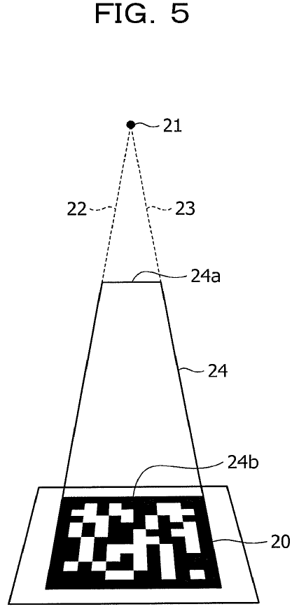

FIG. 5 is a diagram illustrating an example of a perspective. A perspective 24 illustrated in FIG. 5 is an example of a perspective set by using (x1,y1), (x2,y1), and the specific coordinates between which the values of the Y axis on the line segments 22 and 23 are same in FIG. 4.

Next, the generation unit 132 detects a depth, based on the coordinates of the marker 20. For example, the generation unit 132 detects the depth based on a ratio of two side that intersect with the axes of the perspective 24 illustrated in FIG. 5, for example, sides 24a and 24b. The generation unit 132 sets a depth level n to the perspective, based on the detected depth, that is, a distance between the marker 20 and the vanishing point 21. Here, the depth level n is information corresponding to a degree of separation between the camera 111 and the subject position. That is, the perspective to which the depth level n has been set is information used to associate information corresponding to a degree of separation between the camera 111 and the subject position with the part. That is, the generation unit 132 sets a vanishing point based on line segments obtained by extending two sides from among the four sides of the image of the reference object and that intersect with each other, and generates information used to associate information corresponding to a degree of separation with the part based on the vanishing point.

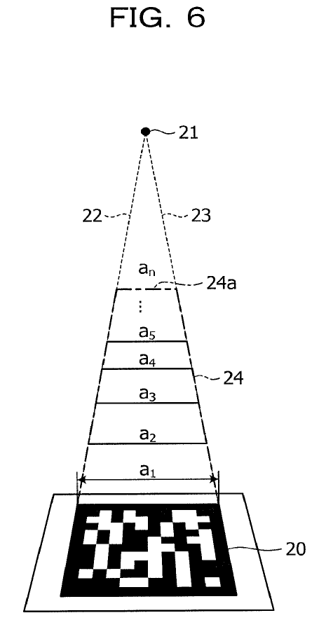

FIG. 6 is a diagram illustrating an example of a depth level. As illustrated in FIG. 6, for example, the generation unit 132 sets a depth level n to the perspective 24. The generation unit 132 sets, for example, a formula of “aₙ=2/(n (n+1))” as the length aₙ of the line segment in the depth level n. Here, “n” is a certain number, but for example, the generation unit 132 sets the value of the length aₙ of the calculated line segment as a value one above a value smaller than the side on the vanishing point 21 side of the perspective 24, for example, the side 24a. In addition, for example, “n” may correspond to the length aₙ of the line segment allowed to be displayed on the display screen when the vanishing point 21 is set on the depth side of the perspective 24. In addition, the generation unit 132 may use formulas of “aₙ=2/(n+1)”, “aₙ=3/(n+2)”, or “aₙ=4/(n+3)” as the length aₙ of the line segment in the depth level n.

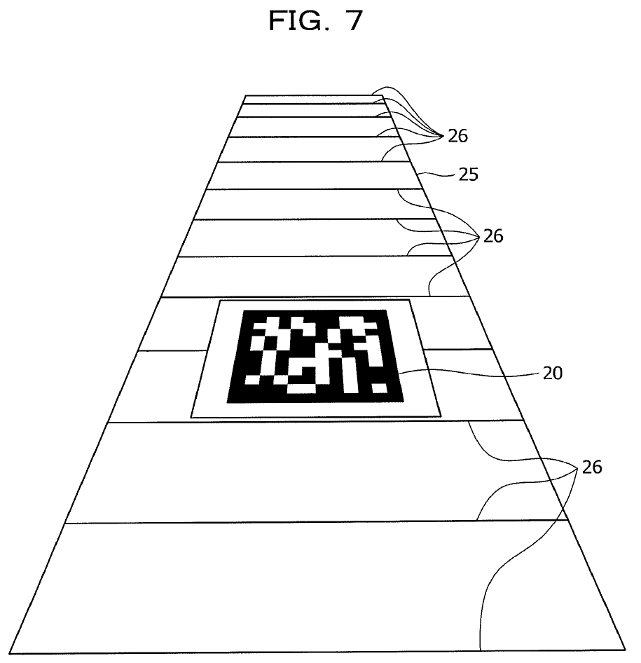

The generation unit 132 sets a scaling ratio, for the perspective to which the depth level n has been set. For example, the generation unit 132 displays the perspective so as to enlarge or reduce the perspective, based on a pinch-in or pinch-out operation performed on the display operation unit 112 through the user's fingers. FIG. 7 is a diagram illustrating an example of a perspective enlarged after setting of the depth level. A perspective 25 illustrated in FIG. 7 is a perspective enlarged after setting of a depth level 26 to the perspective 24 illustrated in FIG. 6. The perspective 25 may also be enlarged to the front side of the marker 20, and the marker 20 may be positioned around the center of the perspective 25 as illustrated in FIG. 7. For example, the generation unit 132 sets a ratio of the size of the perspective at the time at which the user has released the finger to the size of the original perspective, as the scaling ratio. The generation unit 132 associates the perspective including the set scaling ratio and depth level with the marker to generate perspective information, and store the generated perspective information in the perspective information storage unit 122. The perspective to which the depth level and the scaling ratio have been set remains displayed on the display operation unit 112. That is, the generation unit 132 displays information used to associate information corresponding to a degree of separation with the part, on the captured image.

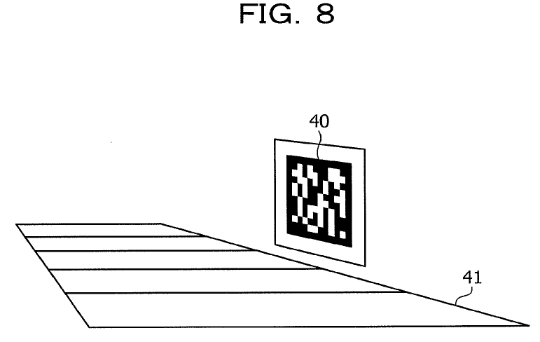

In addition, when the marker is on a wall surface, the generation unit 132 may arrange a perspective on the floor surface. FIG. 8 is a diagram illustrating an example of a perspective on the floor surface, which corresponds to a marker on a wall surface. In the example of FIG. 8, for a marker 40 on the wall surface, a perspective that is not illustrated is set to the wall surface similar to FIGS. 5 and 6. The generation unit 132 sets a perspective 41 on the floor surface, the vanishing point of which is the same as the not-illustrated perspective on the wall surface. As illustrated in FIG. 8, the generation unit 132 may set the perspective 41 on the floor surface for the marker 40 on the wall surface. That is, when an image of a reference object is on the wall surface, the generation unit 132 displays, on the floor surface, information used to associate information corresponding to the degree of separation with the part, that is, a perspective. The processing in which the perspective is displayed on the floor surface may be executed by the display control unit 134. In addition, the generation unit 132 may set the perspective on the wall surface for the marker on the wall surface.

Returning to FIG. 1, when the perspective information is generated, the obtaining unit 133 detects an operation by the user to associate the object data with a certain part in the captured image. When the obtaining unit 133 detects the operation, the obtaining unit 133 obtains information corresponding to a degree of separation associated with the certain part, with reference to the perspective information storage unit 122.

That is, the obtaining unit 133 accepts selection of object data to be arranged in the captured image, based on a user operation. When the obtaining unit 133 accepts the selection of the object data, the obtaining unit 133 determines whether setting of a scaling ratio of the perspective has been performed, with reference to the perspective information storage unit 122. When the scaling ratio of the perspective has been performed, the obtaining unit 133 applies the sett scaling ratio. When the scaling ratio of the perspective is not performed, the obtaining unit 133 sets a scaling ratio, based on a user operation. The obtaining unit 133 outputs a display instruction of the object data the selection of which has been accepted, to the display control unit 134.

When the object data is moved within the captured image by a user operation, the obtaining unit 133 obtains a depth level corresponding to a part in the captured image of the object data moved in accordance with the operation, with reference to the perspective information storage unit 122. That is, the obtaining unit 133 obtains information corresponding to a degree of separation associated with the part in the captured image of the object data, that is, the depth level, in response to the user operation. The obtaining unit 133 outputs the obtained depth level to the display control unit 134.

When an operation to confirm the display size of the object data is input from the user, the obtaining unit 133 confirms a depth level and coordinate information of the object data. That is, the obtaining unit 133 associates the coordinate information of the object data with the perspective information. The obtaining unit 133 transmits the associated coordinate information of the object data and perspective information, to the server 200 through the communication unit 110.

When the obtaining unit 133 reedits the object data and the marker on which authoring has been performed once, the obtaining unit 133 transmits a perspective information obtaining instruction to the server 200 through the network N. The obtaining unit 133 obtains perspective information corresponding to the perspective information obtaining instruction from the server 200 through the network N, and may reedit the object data based on the obtained perspective information.

When the display instruction is input to the display control unit 134 from the obtaining unit 133, the display control unit 134 displays the object data that is a target of the display instruction, for example, on the frontmost side of the perspective in the captured image. The display control unit 134 may display the object data on a certain location in the captured image.

When a depth level depending on a user operation is input to the display control unit 134 from the user, the display control unit 134 changes the display size of the object data in accordance with the input depth level and displays the object data. That is, when the object data is moved to the front side or the back side of the perspective, the display control unit 134 displays the object data so as to change the display size to become larger on the front side and change the display size to become smaller on the back side. That is, the depth level is size information on the object data corresponding to a degree of separation.

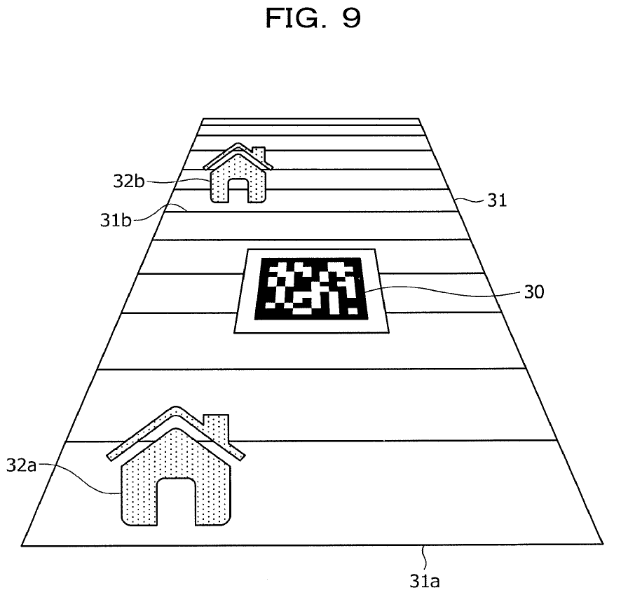

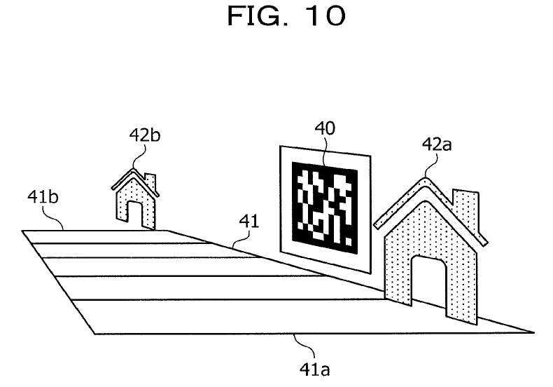

Here, a change in the display size of object data is described with reference to FIGS. 9 and 10. FIG. 9 is a diagram illustrating an example of a change in the display size of object data. In the example of FIG. 9, a perspective 31 is set for a marker 30. In addition, object data 32a that has been arranged based on a user operation is displayed with the display size corresponding to a depth level 31a on the frontmost side. Next, when the object data 32a is moved to the back side by a user operation, the object data 32a becomes object data 32b. The object data 32b is displayed with the display size corresponding to a depth level 31b, that is, the object data 32b is displayed smaller than the object data 32a.

FIG. 10 is a diagram illustrating another example of a change in the display size of object data. In the example of FIG. 10, the perspective 41 is set on the floor surface for the marker 40 attached to the wall surface. In addition, object data 42a that has been arranged based on a user operation is displayed with the display size corresponding to a depth level 41a on the frontmost side. Next, when the object data 42a is moved to the back side by a user operation, the object data 42a becomes object data 42b. The object data 42b is displayed with the display size corresponding to a depth level 41b, that is, the object data 42b is displayed smaller than the object data 42a. In FIGS. 9 and 10, it is assumed that the initially-arranged object data has a display size corresponding to the depth level on the frontmost side due to the user operation, but may has a display size corresponding to a specific depth level.

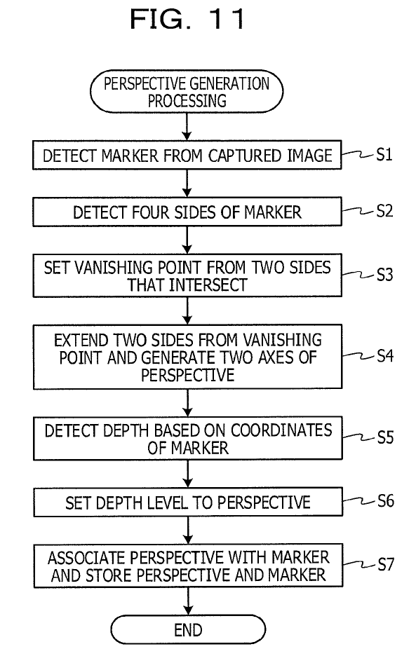

An operation of the display control system 1 according to a first embodiment is described below. First, perspective generation processing is described with reference to FIG. 11. FIG. 11 is a flowchart illustrating an example of perspective generation processing according to the embodiment.

A captured image is input to the determination unit 131 of the information processing device 100 from the camera 111. The determination unit 131 receives the input captured image. The determination unit 131 detects a marker from the received captured image (Step S1). When the determination unit 131 detects the marker from the captured image, the determination unit 131 outputs a perspective generation instruction to the generation unit 132.

When the perspective generation instruction is input to the generation unit 132 from the determination unit 131, the generation unit 132 detects the four sides of the detected marker (Step S2). The generation unit 132 sets a vanishing point from line segments that is obtained by extending two sides from among the detected four sides and that intersect with each other (Step S3). In addition, the generation unit 132 extends the two sides from the set vanishing point to generate two axes of the perspective (Step S4).

Next, the generation unit 132 detects a depth based on the coordinates of the marker 20 (Step S5). The generation unit 132 sets a depth level to the perspective, based on the detected depth (Step S6). The generation unit 132 sets a scaling ratio for the perspective to which the depth level has been set. The generation unit 132 associates the perspective including the set depth level and scaling ratio with the marker to generate perspective information, and store the generated perspective information in the perspective information storage unit 122 (Step S7). As a result, the information processing device 100 may generate the perspective to which the depth level has been set.

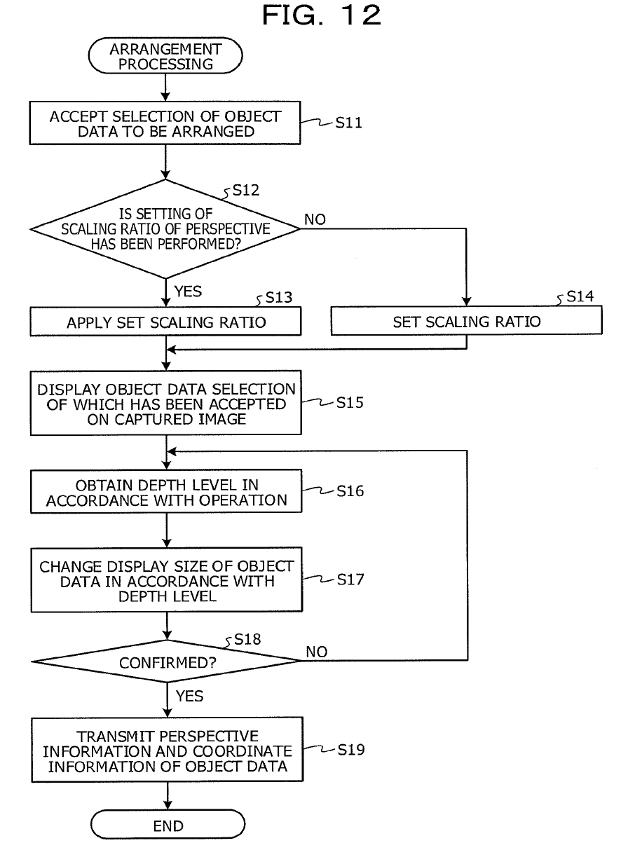

Arrangement processing to arrange object data in a generated perspective is described below with reference to FIG. 12. FIG. 12 is a flowchart illustrating an example of arrangement processing according to the embodiment.

When the perspective information is generated, the obtaining unit 133 of the information processing device 100 accepts selection of object data to be arranged in the captured image, based on a user operation (Step S11). When the obtaining unit 133 accepts the selection of the object data, the obtaining unit 133 determines whether setting of a scaling ratio of the perspective has been performed, with reference to the perspective information storage unit 122 (Step S12). When setting of a scaling ratio of the perspective has been performed (Yes in Step S12), the obtaining unit 133 applies the set scaling ratio (Step S13). When setting of a scaling ratio of the perspective is not performed (No in Step S12), the obtaining unit 133 performs setting of a scaling ratio, based on the user operation (Step S14). The obtaining unit 133 outputs a display instruction of the object data the selection of which has been accepted, to the display control unit 134. When the display instruction is input to the display control unit 134 from the obtaining unit 133, the display control unit 134 displays the object data that is a target of the display instruction on the captured image (Step S15).

The obtaining unit 133 obtains a depth level associated with a certain part in the captured image of the object data, in accordance with a user operation (Step S16). The obtaining unit 133 outputs the obtained depth level to the display control unit 134. When the depth level corresponding to the user operation is input to the display control unit 134 from the obtaining unit 133, the display control unit 134 changes the display size of the object data in accordance with the input depth level and displays the object data (Step S17).

The obtaining unit 133 determines whether an operation to confirm the display size of the object data has been input from the user (Step S18). When the obtaining unit 133 determines that the operation to confirm the display size is not input from the user (No in Step S18), the flow returns to Step S16. When the operation to confirm the display size has been input from the user (Yes in Step S18), the obtaining unit 133 confirms the coordinate information of the object data and the depth level. That is, the obtaining unit 133 associates the coordinate information of the object data with the perspective information. The obtaining unit 133 transmits the associated perspective information and coordinate information of the object data to the server 200 (Step S19). The server 200 stores the received perspective information and coordinate information of the object data in the database. As a result, the information processing device 100 may easily perform setting of the display size of the object data. That is, the information processing device 100 may easily adjust the size of the object data set by the user. In addition, the size of the object data is independent of the user who performs the operation, so that the information processing device 100 may make the representation of the depth uniform.

As described above, when the information processing device 100 receives an image captured by the imaging device, the information processing device 100 determines whether an image of a reference object is included in the captured image. In addition, when the image of the reference object is included in the captured image, the information processing device 100 generates information used to associate information corresponding to a degree of separation between the camera 111 and the subject position, with the part, based on the shape of the image of the reference object. In addition, when the information processing device 100 detects an operation to associate object data with a certain part in the captured image, the information processing device 100 obtains information corresponding to a degree of separation associated with the part, with reference to the generated information. In addition, the information processing device 100 displays the object data on the captured image with the size corresponding to the information corresponding to the obtained degree of separation. As a result, setting of the display size of the object data may be performed easily.

In addition, in the information processing device 100, information corresponding to a degree of separation is size information on object data corresponding to the degree of separation. As a result, the display size of the object data may be set in accordance with the degree of separation.

In addition, the information processing device 100 sets a vanishing point based on line segments obtained by extending two sides from among the four sides of the image of the reference object and that intersect with each other, and generates information used to associate information corresponding to a degree of separation between the camera 111 and the subject position, with the part, based on the vanishing point. As a result, a perspective corresponding to an inclination of the reference object may be generated.

In addition, the information processing device 100 displays the information used to associate the information corresponding to the degree of separation between the camera 111 and the subject position with the part, on the captured image. As a result, the depth level may be displayed for the user easily.

In addition, when the image of the reference object is on the wall surface, the information processing device 100 displays the information used to associate the information corresponding to the degree of separation between the camera 111 and the subject position with the part, on the floor surface. As a result, even when the reference object is on the wall surface, authoring using the depth level is performed easily.

In the above-described embodiment, the authoring, that is, the perspective generation processing and the arrangement processing are executed for an image captured by the camera 111 of the information processing device 100, but the embodiment is not limited to such an example. For example, authoring may be performed on an image captured by another imaging device.

In addition, in the above-described embodiment, the case is described in which a single vanishing point is used, but the embodiment is not limited to such an example. For example, when a marker is imaged obliquely, two vanishing points are generated, so that the two vanishing points may be used, or the user may select a vanishing point to which a perspective is set.

In addition, the configuration elements of the illustrated units may not be physically configured as illustrated in the drawings. That is, a specific configuration of distribution or integration of the units is not limited to the illustrated configuration, and all or a part of the units may be configured to be distributed or integrated functionally or physically in an arbitrary unit in accordance with various conditions such as a load and a usage. For example, the determination unit 131 and the generation unit 132 may be integrated with each other. In addition, the pieces of illustrated processing are not limited to the above-described order, and may be carried out at the same time, and the order of the pieces of illustrated processing may be changed as long as the processing contents do not conflict.

In addition, all or a certain part of the various processing functions executed in the devices may be executed on a CPU (or a microcomputer such as a MPU or a micro controller unit (MCU)). In addition, all or a certain part of the various processing functions may be executed on a program analyzed and executed by a CPU (or a microcomputer such as a MPU or a MCU) or on hardware by wired logic.

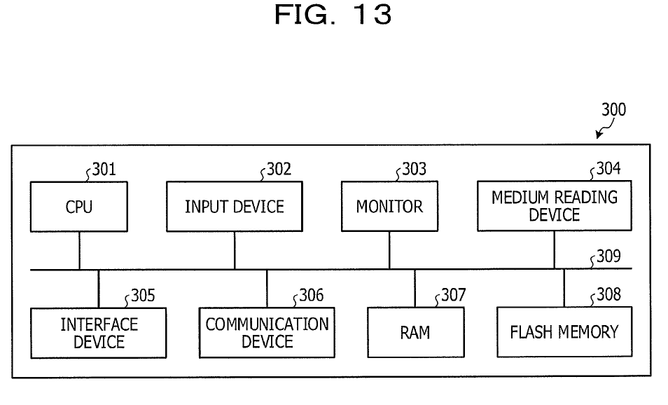

Here, the various pieces of processing described in the above-described embodiments may be realized when a program prepared in advance is executed by a computer. Therefore, an example of a computer that executes a program including functions similar to those of the above-described embodiments is described below. FIG. 13 is a diagram illustrating an example of a computer that executes a display control program.

As illustrated in FIG. 13, a computer 300 includes a CPU 301 that executes various pieces of calculation processing, an input device 302 that accepts data input, and a monitor 303. In addition, the computer 300 includes a medium reading device 304 that reads a program and the like from a storage medium, an interface device 305 used to perform connection with various devices, and a communication device 306 used to perform connection with another information processing device and the like through a wired or wireless communication. In addition, the computer 300 includes a RAM 307 that temporarily stores various pieces of information and a flash memory 308. In addition, the devices 301 to 308 are coupled to a bus 309.

A display control program including functions similar to those of the processing units such as the determination unit 131, the generation unit 132, the obtaining unit 133, and the display control unit 134 illustrated in FIG. 1 is stored in the flash memory 308. In addition, various pieces of data used to realize the object data storage unit 121, the perspective information storage unit 122, and the display control program are stored in the flash memory 308. For example, the input device 302 accepts input of various pieces of information including operation information from the user of the computer 300. For example, the monitor 303 displays various screens including a display screen for the user of the computer 300. For example, a camera and the like are coupled to the interface device 305. For example, the communication device 306 includes a function similar to that of the communication unit 110 illustrated in FIG. 1, and is coupled to the network N and transmits and receives various pieces of information to and from the server 200.

The CPU 301 executes various pieces of processing by reading each program stored in the flash memory 308, deploying the program to the RAM 307, and executing the program. In addition, the program may cause the computer 300 to function as the determination unit 131, the generation unit 132, the obtaining unit 133, and the display control unit 134 illustrated in FIG. 1.

The above-described display control program may not be stored in the flash memory 308. For example, the computer 300 may read and execute the program stored in a storage medium allowed to be read by the computer 300. The storage medium allowed to be read by the computer 300 corresponds to, for example, a portable recording medium such as a CD-ROM, a DVD disk, or a universal serial bus (USB) memory, a semiconductor memory such as a flash memory, a hard disk drive, or the like. In addition, the display control program may be stored in a device coupled to a public line, the Internet, a LAN, read from the device by the computer 300, and executed by the computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display method executed by a computer, the method comprising:
receiving an image captured by a camera;
detecting a reference object in the image;
receiving designation indicating a first position in the image;
determining a size of an object in accordance with the first position and a captured shape of the reference object in the image; and
superimposing the object on the first position with the determined size.

2. The display method according to claim 1, wherein the reference object is an AR marker.

3. The display method according to claim 1, further comprising, prior to the determining: accepting information specifying the object.

4. The display method according to claim 1, further comprising:
receiving designation indicating a second position;
determining a second size of the object in accordance with the second position; and
superimposing the object on the second position with the second size.

5. The display method according to claim 1, wherein the determining includes,
generating a plurality of depth degrees in accordance with the captured shape of the reference object, the plurality of depth degrees being associated with parts of the image respectively,
specifying a first depth degree in accordance with the first position, the first depth degree being included in the plurality of depth degrees, and
determining the size of the object in accordance with the first depth degree.

6. The display method according to claim 5, wherein the first depth degree is corresponding to a degree of separation between the camera and a subject, the subject being captured in the first position in the image.

7. The display method according to claim 5, wherein a plurality of sizes of the object are associated with the plurality of depth degrees respectively.

8. The display method according to claim 5, wherein the captured shape of the reference object includes four sides, and the generating includes,
determining a vanishing point obtained by extending two sides among the four sides, and
generating a plurality of depth degrees based on the vanishing point.

9. The display method according to claim 5, further comprising displaying a perspective indicating the plurality of depth degrees on the image.

10. The display method according to claim 5, wherein the plurality of depth degrees are based on a floor when the reference object is on a wall.

11. A display device comprising:
a memory; and
a processor coupled to the memory and the processor configured to:
receive an image captured by a camera,
detect a reference object in the image,
receive designation indicating a first position in the image,
perform determination of a size of an object in accordance with the first position and a captured shape of the reference object in the image, and
superimpose the object on the first position with the determined size.

12. The display device according to claim 11, wherein the determination includes,
generating a plurality of depth degrees in accordance with the captured shape of the reference object, the plurality of depth degrees being associated with parts of the image respectively,
specifying a first depth degree in accordance with the first position, the first depth degree being included in the plurality of depth degrees, and
determining the size of the object in accordance with the first depth degree.

13. A non-transitory computer-readable recording medium storing a program that causes a computer to execute a display process comprising:
receiving an image captured by a camera;
detecting a reference object in the image;
receiving designation indicating a first position in the image;
determining a size of an object in accordance with the first position and a captured shape of the reference object in the image; and
superimposing the object on the first position with the determined size.

14. The display process according to claim 13, wherein the determining includes,
generating a plurality of depth degrees in accordance with the captured shape of the reference object, the plurality of depth degrees being associated with parts of the image respectively,
specifying a first depth degree in accordance with the first position, the first depth degree being included in the plurality of depth degrees, and
determining the size of the object in accordance with the first depth degree.
